(19) United States
(12) Patent Application Publication
(10) Pub. No.: US 2008/0206571 A1
(43) Pub. Date: Aug. 28, 2008

(54) COATING COMPOSITIONS

(76) Inventors: Marc Charles F. Berckmans, Bruxelles (BE); Detlev Glittenberg, Krefeld (DE); Rudy Roux, Douai (FR)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/038,622

(22) Filed: Feb. 27, 2008

(30) Foreign Application Priority Data
Feb. 27, 2007 (EP) 07103158.7

(51) Int. Cl. D21H 19/58; C08L 3/00; C08L 1/26

(52) U.S. Cl. 428/411.1; 536/102; 106/206.1; 524/53; 524/52; 524/47; 106/162.81; 106/217.01; 106/15.05

(57) ABSTRACT

A coating composition comprising a starchy material, said material having:
a number average molecular weight (Mn) of 3 500 to 20 000 Daltons,
a granular structure before solubilisation,
a solubility at pH 7 and 20° C. (S1) of 30-90%, and
a solubility at pH 10 and 35° C. (S2) which is at least 10% greater than S1.

### TECHNICAL FIELD OF THE INVENTION

The present invention relates to coating compositions and, in particular, to paper coating compositions containing specific starchy materials.

### BACKGROUND OF THE INVENTION

Coating compositions are used on a number of substrates including, amongst others, metals, plastics, textiles and paper. They help to protect and enhance the feel and appearance of the surfaces to which they are applied. They may also improve other characteristics such as printability, water resistance, reflectivity or strength.

The make up of a coating composition will depend on its desired end-use. Typically, a paper coating composition (also known as a “coating colour”) will contain pigments, binders and thickeners.

Thickeners, in particular, have to be chosen very carefully as they are responsible for determining the coating composition's rheological properties (both at high and low shear) and will contribute to it having an appropriate stability (e.g. during storage or at the high temperatures required for drying). To this end, a number of starch products have been developed. The aim of these developments has been the production of a cheap, highly stable, highly viscous, cold water soluble starch.

Cold water solubility is indeed considered important if surface graininess is to be avoided. It can also ease application of the coating composition and generally improve the overall characteristics of the finished product. A lot of research has therefore gone into finding new ways of increasing the cold water solubility of starch thickeners. U.S. Pat. No. 6,191,116 (National Starch), for example, describes a process for obtaining 100% cold water soluble starch derivatives suitable for use in coating compositions. The process involves dehydrating a starch substrate and then dextrinising it under anhydrous conditions.

Unfortunately, despite all these efforts, the cold water soluble starches currently being used in the industry still have a number of drawbacks, the most important one being cost. Conventional cold water soluble starches are prepared by gelatinisation in the presence of water followed by drying. The drying step is expensive in terms of both time and energy. The resulting high costs limit the use of these starches to higher added value coating applications.

It is therefore apparent that there is a need in the art for a new cold water soluble starch which can be used at high concentrations in coating compositions without prohibitively increasing their cost. The present invention provides such a starch.

### SUMMARY OF THE INVENTION

In a first aspect, the present invention provides a coating composition comprising a starchy material, said material having:

a number average molecular weight (Mn) of 3 500 to 20 000 Daltons,

a granular structure before solubilisation,

a solubility at pH 7 and 20° C. (S1) of 30-90%, and

a solubility at pH 10 and 35° C. (S2) which is at least 10% greater than S1.

In a further aspect of the present invention, there is provided a paper coating composition as defined above.

In a yet further aspect of the present invention, there is provided a paper product coated with the above coating composition.

In a final aspect of the present invention, there is provided the use of a starchy material as defined above for the production of a coating composition.

### BRIEF DESCRIPTION OF THE FIGURES

FIG. 1—compares water release properties of a standard precoat composition and a precoat composition of the present invention.

FIG. 2—compares the paper gloss levels of a paper product coated with a standard precoat composition and with a precoat composition of the present invention.

FIG. 3—compares the printing gloss levels of a paper product coated with a standard precoat composition and with a precoat composition of the present invention.

FIG. 4—compares the pick-dry properties of a paper product coated with a standard precoat composition and with a precoat composition of the present invention.

FIG. 5—compares water release properties of a standard topcoat composition and a topcoat composition of the present invention.

FIG. 6—compares the paper gloss levels of a paper product coated with a standard topcoat composition and with a topcoat composition of the present invention.

FIG. 7—compares the printing gloss levels of a paper product coated with a standard topcoat composition and with a topcoat composition of the present invention.

FIG. 8—compares the mottling levels of a paper product coated with a standard topcoat composition and with a topcoat composition of the present invention.

FIG. 9—compares levels of coating cracking for a paper product coated with a standard topcoat composition and with a topcoat composition of the present invention.

### DETAILED DESCRIPTION OF THE INVENTION

The coating composition of the present invention comprises a starchy material which has:

a number average molecular weight (Mn) of 3 500 to 20 000 Daltons,

a granular structure before solubilisation,

a solubility at pH 7 and 20° C. (S1) of 30-90%, and

a solubility at pH 10 and 35° C. (S2) which is at least 10% greater than S1.

The starchy material may be derived from any native or modified starch, including cereal starches, leguminous starches, root or tuber starches, fruit starches and waxy or high amylose variants thereof. Preferably, the starchy material will be derived from a starch selected from the group consisting of: potato starch, corn starch, wheat starch, tapioca starch, pea starch, waxy maize starch, waxy potato starch and mixtures of two or more thereof.

The expression “modified starch” as used herein refers to a starch whose structure has been altered by chemical, enzymatic or heat treatment. For instance, the starch substrate may be selected from esterified, etherified, cross-linked, oxidised or acid modified starches or mixtures of two or more thereof. Preferably, however, the starchy material will not be strongly degraded. In other words, it will preferably have a dextrose equivalence (DE) value of less than 5, more preferably of less than 4, more preferably of less than 3, more preferably of less than 2 (wherein DE is measured using the Schoor1 Method).

Before solubilisation, the starchy material of the present invention will have a granular structure. Native starch granules exist in many shapes and sizes. Under the influence of heat and in the presence of water, these granules swell and, eventually, disperse leading to a colloidal solution. Thus, the starchy material of the present invention will preferably have, before solubilisation, a granular structure similar to that of its corresponding native starch.

The starchy material of the present invention will have a number average molecular weight (Mn) of 3 500 to 20 000 Daltons. Preferably, it will be between 5 000 and 15 000 Daltons.

The starchy material will have a cold water solubility (S1) of 30-90%, preferably of 45-90%, more preferably of 50-80%. Cold water solubility is measured according to Method 1 set out below and generally refers to the proportion of starch granules that are able to swell in cold water (i.e. at neutral pH and at room temperature), forming a viscous, colloidal dispersion. Thus, cold water soluble starches may also be referred to as “cold water swellable” starches. As mentioned above, it is normally desirable for starches used in coating compositions to have very high levels of cold water solubility. It was therefore surprising to find that the starchy material of the present invention can be effective even at solubilities as low as 30%. Without wishing to be bound by theory, it is indeed believed that, despite being only slightly soluble under the standard conditions mentioned in Method 1, the starchy material of the present invention will fully disperse and solubilise when used in the preparation of a typical industrial coating composition, i.e. at a pH of 8-10 and at a temperature of 30-50° C. In any event, it should have a solubility (S2) at pH 10/35° C. (see Method 2) which is at least 10% greater than (S1). Preferably, it will have a solubility (S2) of at least 50%. Even more preferably, it will have a solubility (S2) of at least 70%.

Coating compositions are typically used to enhance the feel, appearance and/or functionality of a substrate. As used in relation to the present invention, the term “coating composition” will refer to any aqueous solution or dispersion suitable for such a use, and to dry mixes used in their preparation. In the case of an aqueous solution or dispersion, it should ideally contain 30-75% dry substance by weight.

Preferably, the coating composition of the present invention will be a paper coating composition (also know as a “coating color”). It will advantageously comprise at least 50% dry substance by weight, more preferably 50-80%. The composition will advantageously have a pH of 7 to 12. Preferably, the pH will be from 8 to 10. In addition to the starchy material defined above, it will further contain one or more pigments. It may also contain one or more binders, one or more thickeners and one or more additives.

Examples of suitable pigments include: clays such as kaolin but also structured and calcined clays, hydrated aluminum silicates, bentonite, natural and synthetic calcium carbonate, calcium sulphate (gypsum), silicas, precipitated silicas, titanium dioxide, alumina, aluminium trihydrate, plastic (polystyrene) pigments, satin white, talc, barium sulphate, zinc oxide and mixtures of two or more thereof. The appropriate pigment will easily be selected by a skilled person depending on the type of coating composition to be obtained.

The addition of one or more binders is optional. They can indeed be replaced, either in whole or in part, by the starchy material of the present invention. Where a further binder is required, it can be selected—by way of example only—from carbohydrate-based binders including starch-based binders (such as oxidised or esterified starch) and cellulose binders (such as CMC and hydroxyethyl cellulose), protein binders (such as casein, gelatine, soy protein and animal glues) and synthetic binders, especially latex binders (such as styrene butadiene, styrene acrylate, vinyl polymer based latexes and polyvinyl alcohol) together with mixtures of two or more thereof.

Additional thickeners are also optional. Again, they can be replaced, in whole or in part, by the starchy material of the present invention. If further thickeners are used, they should not account for more than 50% of total thickener content on a dry weight basis. Examples of suitable thickeners include cellulose ethers (such as CMC, hydroxyethyl cellulose, hydroxypropyl cellulose, ethylhydroxyethyl cellulose and methyl cellulose), alginates (such as sodium alginate), xanthan, carrageenans, galactomannans (such as guar), native or modified starches (such as roll-dried starch), synthetic polymers (such as polyacrylates) and mixtures of two or more thereof.

Examples of possible additives, if used, include: surfactants (e.g. cationic surfactants, anionic surfactants, non-ionic surfactants, amphoteric surfactants and fluorinated surfactants), hardeners (e.g. active halogen compounds, vinylsulfone compounds, epoxy compounds, etc.), dispersing agents (e.g. polyacrylates, polyphosphates, polycarboxylates, etc.), flowability improvers, lubricants (e.g. calcium, ammonium and zinc stearate, wax or wax emulsions, alkyl ketene dimer, glycols, etc.), antifoamers (e.g. octyl alcohol, silicone-based antifoamers, etc.), releasing agents, foaming agents, penetrants, optical brighteners (e.g. fluorescent whiteners), preservatives (e.g. benzisothiazolone and isothiazolone compounds), biocides (e.g. metaborate, thiocyanate, sodium benzonate, etc.), yellowing inhibitors (e.g. sodium hydroxymethyl sulfonate, sodium p-toluenesulfonate, etc.), ultraviolet absorbers (e.g. benzotriazole compounds having a hydroxy-dialkylphenyl group at the 2 position), antioxidants (e.g. sterically hindered phenol compounds), insolubilisers, antistatic agents, pH regulators (e.g. sodium hydroxide, sulfuric acid, hydrochloric acid, etc.), water-resisting agents (e.g. ketone resin, anionic latex, glyoxal, etc.), wet and/or dry strengthening agents (e.g. glyoxal based resins, oxidised polyethylenes, melamine resins, urea formaldehyde, etc.), cross-linking agents, gloss-ink holdout additives, grease and oil resistance additives, leveling and evening aids (e.g. polyethylene emulsions, alcohol/ethylene oxide, etc.), and mixtures of two or more thereof.

The amount of each of these compounds to be added, if at all, will be determined in accordance with standard practice and with the desired properties of the particular coating composition in mind. If used, pigments will generally be present in the largest amount. All other components can therefore be expressed relative to pigment content, i.e. as parts per 100 parts pigment. Thus, for 100 parts pigment, the coating composition of the present invention will preferably contain 1-20 parts starchy material, 0-50 parts binder and 0-5 parts additives. Advantageously, it will contain 100 parts pigment, 5-10 parts starchy material, 5-25 parts binder and 0-2 parts additives. Alternatively, the make-up of the composition can be expressed relative to total dry weight. Thus, the composition will preferably contain 0-95% pigment, 0.5-15% starchy material, 0-45% additional binder, 0-5% additional thickener and 0-2% additives. Advantageously, it will contain 30-95% pigment, 4-10% starchy material, 1-35% binder, 0-2% additional thickener and 0-2% additives. The exact make-up of the composition will readily be determined by the skilled person depending on the desired end properties of the coating composition. What has been found is that the total dry solids of the coating composition can be increased by using the starchy material defined herein. This is associated with a number of benefits including reduced costs (linked to easier preparation, reduced waste, reduced water release, reduced need for additional thickeners and/or synthetic binders for example) and improved results (such as improved paper and printing gloss, improved surface strength and appearance and lower coating cracking thanks to a smoother, more uniform coating layer).

The composition can be prepared using standard methods known to those skilled in the art (with the components of the composition added to the water one after the other or all at once). Advantageously, however, it can also be prepared by adding the dry starchy material directly to the coating mixture. The composition can then be stored or directly applied to its substrate. Specifically, the present invention provides paper products coated with the paper coating composition defined above.

The terms “paper” and “paper product” as used herein refer to sheet material of any thickness, including, for example, paperboard, cardboard and corrugated board. The term “paper web”, by contrast, refers to the continuous ribbon of paper, in its full width, at any stage during the paper making process.

Coating of the paper products can be carried out on-line in the paper machine or on a separate coating machine. Methods of applying coating compositions to paper products are well known in the art. They include, for example, air knife coating, rod coating, bar coating, wire bar coating, spray coating, brush coating, cast coating, flexible blade coating, gravure coating, jet applicator coating, short dwell coating, slide hopper coating, curtain coating, flexographic coating, size-press coating, reverse roll coating and transfer roll coating (metered size press or gate roll coating). According to the quality of paper or board desired and its end use, it can be coated only on one or on both sides. Each side can be coated only once or a plurality of times on one or both sides, provided that at least one of the coatings is in accordance with the present invention. By way of example, a premium coated paper will typically include a pre-coat, middle-coat and top-coat wherein at least one of the coats is in accordance with the present invention.

After the coating step, the paper is dried and optionally calendered to improve surface smoothness and gloss. Drying methods include, but are not limited to, air or convection drying (e.g. linear tunnel drying, arc drying, air-loop drying, sine curve air float drying, etc.), contact or conduction drying and radiant energy drying (e.g. infrared or microwave drying). Calendering is achieved by passing the coated paper between calendar nips or rollers (preferably elastomer coated nips or rollers) one or more times. For best results, calendering should be carried out at elevated temperatures. Ideally for each coating step, a dry coating weight in the range from about 4 to about 30 g/m², preferably from about 6 to about 20 g/m² will be achieved, with a coating thickness of 1-50 μm.

The present invention will now be described in more detail by way of the following non-limiting examples.

### EXAMPLES

### Example 1

### Precoating of Fine Paper Via Metered Size Press

1) Preparation of Materials

| | Reference | Precoat of the |
|---|---|---|
| | Precoat | invention |
| Coarse Ground Calcium Carbonate (parts) | 100 | 100 |
| Styrene Butadiene Latex (parts) | 6.5 | 5.5 |
| Chrono HV 117¹ (parts) | — | 3 |
| C*Film TCF 07311 (parts) | 7 | 5 |
| Fluorescence Whitening Agent (parts) | 0.5 | 0.5 |
| Polyacrylate Thickener (parts) | 0.3 | 0.1 |
| Dry Solids (%) | 66.1 | 68.2 |

¹Starchy material in accordance with the invention

| | Standard | Standard |
|---|---|---|
| | Middlecoat | Topcoat |
| Ground Calcium Carbonate (parts) | 100 | 60 |
| Kaolin clay (parts) | — | 40 |
| Middlecoat latex (parts) | 5 | — |
| Topcoat Latex (parts) | — | 6.5 |
| C*Film TCF 07311 (parts) | 7 | — |
| CMC (parts) | 0.3 | 0.35 |
| Fluorescence Whitening Agent (parts) | 0.1 | 0.2 |
| PVOH (parts) | — | 1 |
| Ca-stearate (parts) | — | 0.25 |
| Dry Solids (%) | 69 | 68.5 |

Reference precoat: the jet cooked (130° C.) starch paste was added hot (>80° C.) into the pigments prior to the addition of latex and additives.

Precoat of the invention: Chrono HV 117 was mixed under high-shear conditions for 8 minutes in the pigment slurry/C*Film blend prior to the addition of latex, FWA and synthetic thickener.

2) Coating: 84 g/m² base paper with 10 g/m² per side pre-coat (MSP, 1000 m/min), followed by standard middle and top coats (free jet applicator, 1400 m/min). Paper was calendered at 200 m/min, 80° C. and at a nip pressure of 180 kN/m.

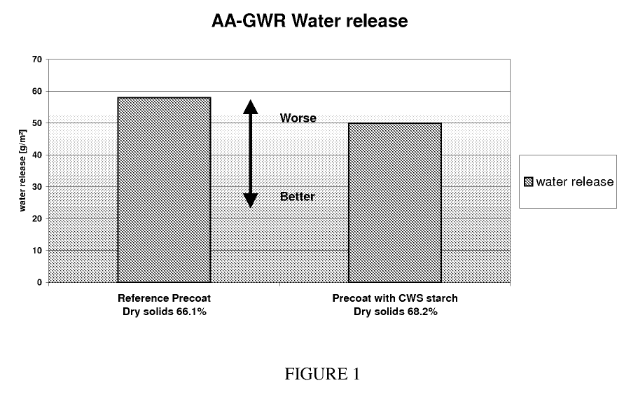

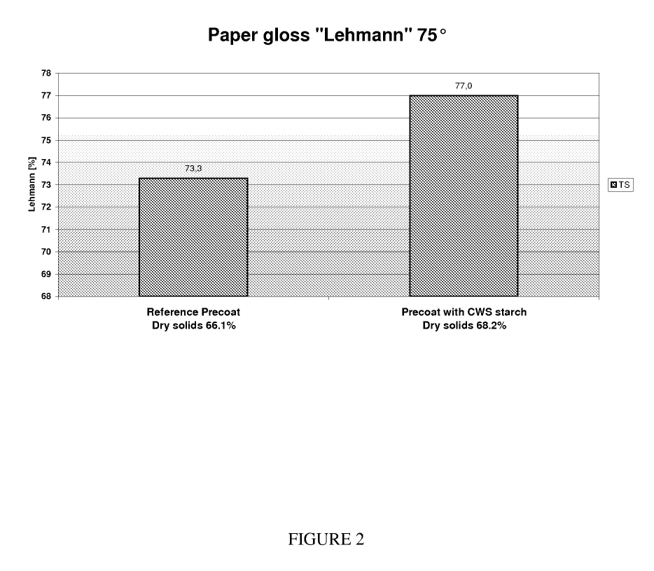

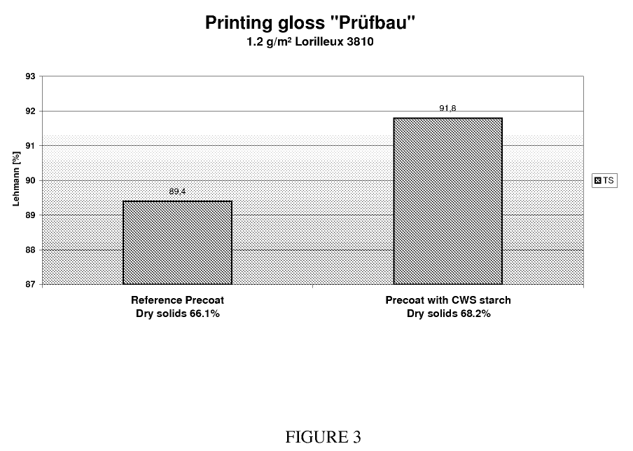

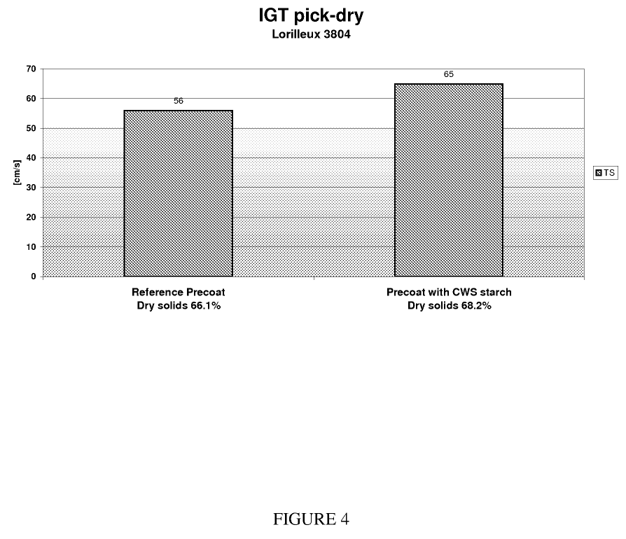

The products were analysed using standard testing methods (the AA-GWR water release test, the Lehmann paper gloss 75° test, the Pfübau printing gloss test and the IGT pick-dry test). The results of these tests are shown in FIGS. 1 to 4. As can be seen, coating compositions according to the present invention lead to reduced water release, improved gloss (both paper and printing) and improved pick-dry properties.

### Example 2

### Top Coating of Fine Paper with Free Jet Applicator

1) Preparation of Materials

| | Standard | Standard |
|---|---|---|
| | Precoat | Middlecoat |
| Coarse Ground Calcium Carbonate (parts) | 100 | 65 |
| Fine Ground Calcium Carbonate (parts) | — | 35 |
| Precoat latex (parts) | 6.5 | — |
| Middlecoat latex(parts) | — | 5 |
| C*Film TCF 07311 (parts) | 7 | 7 |
| CMC (parts) | — | 0.3 |
| Fluorescence Whitening Agent (parts) | 0.05 | 0.1 |
| Polyacrylate Thickener (parts) | 0.5 | — |
| Dry Solids (%) | 66.5 | 69 |

| | Reference | Topcoat of the |
|---|---|---|
| | Topcoat | invention |
| Fine Ground Calcium Carbonate (parts) | 88 | 88 |
| Kaolin clay (parts) | 12 | 12 |
| Top Latex 1 (parts) | 4.5 | 4 |
| Top Latex 2 (parts) | 1 | 1 |
| Chrono HV 170¹ (parts) | — | 2 |
| C*Film TCF 07311 (parts) | 1 | — |
| Fluorescence Whitening Agent (parts) | 0.05 | 0.05 |
| PVOH (parts) | 0.3 | 0.3 |
| Polyacrylate Thickener (parts) | 0.5 | — |
| Dry Solids (%) | 70.3 | 71.8 |

¹Starchy material in accordance with the invention

Reference topcoat: the jet cooked (130° C.) starch paste was added hot (>80° C.) into the pigments prior to the addition of latex 1 and latex 2. Afterwards, the PVOH, FWA and thickener are added to the suspension.

Topcoat of the invention: Chrono HV 170 was mixed under high-shear conditions for 8 minutes in the pigment slurry/latex blend prior to the addition of PVOH and FWA.

2) Coating: 126 g/m² standard pre and middle coated paper used as base. 10.5 g/m² per side top-coat weight (stiff blade 0.508 mm, 1400 m/min). Paper was calendered at 200 m/min, 80° C. and at a nip pressure of 180 kN/m.

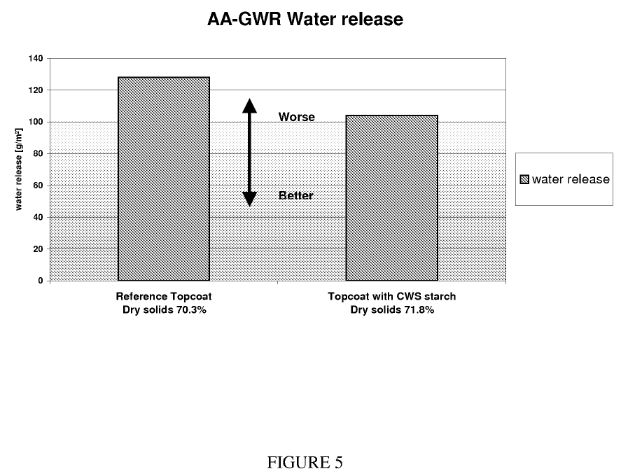

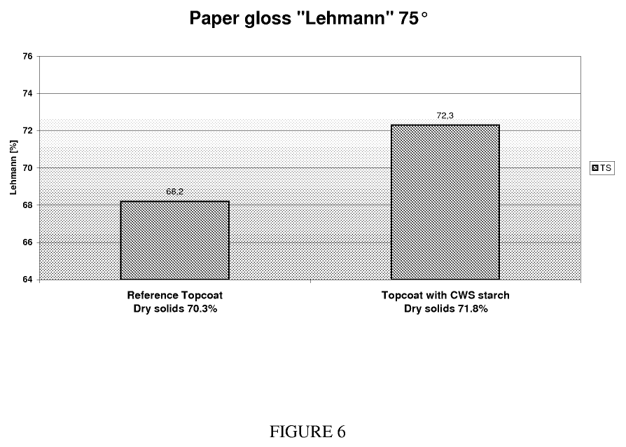

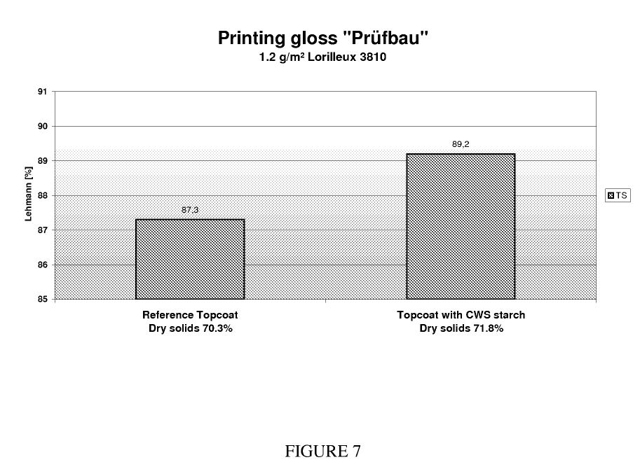

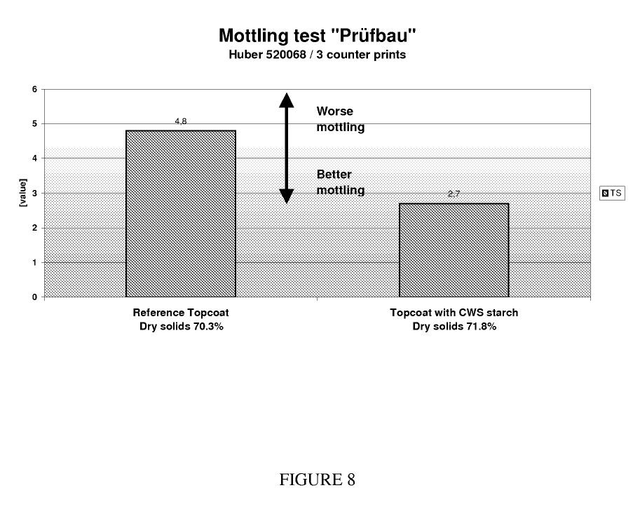

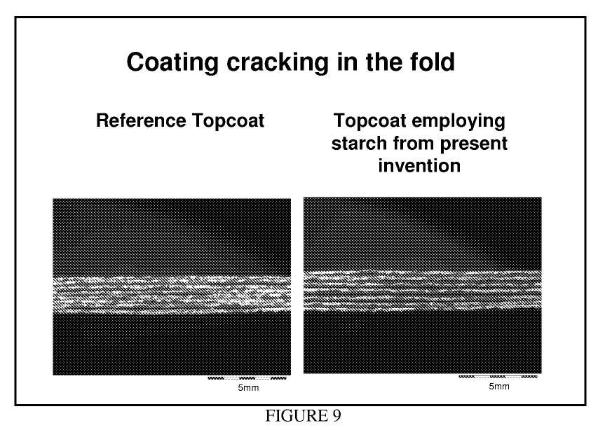

The products were analysed using standard testing methods (the AA-GWR water release test, the Lehmann paper gloss 75° test, the Pfübau printing gloss test, the Pfübau mottling test and the coating cracking in the fold test). The results of these tests are shown in FIGS. 5 to 9. As can be seen, coating compositions according to the present invention lead to reduced water release, improved gloss (both paper and printing), less mottling and reduced cracking in the fold.

### Methods

### Method 1—Cold Water Solubility (S1)

Determine the percent dry substance (DS) of the sample by drying 5 g for 4 hours at 120° C. under vacuum.

Weigh 2 g of sample and transfer to a dry 200 ml Kohlrausch flask. Partially fill with water at 25° C. Shake vigorously until completely in suspension and dilute to volume. Stopper flask and shake gently while submerged in a water bath at 25° C. for a total agitation time of 1 hour.

Filter through a Whatman No. 2V paper, returning the first portion of filtrate. Measure 50 ml of filtrate and transfer to a weighed evaporating dish.

Evaporate to dryness on a steam bath and dry in a vacuum oven for 1 hour at 100° C. Cool in a desiccator and weigh to the nearest mg.

DS,%=100−[(loss in weight,g×100)/(sample weight,g)]

Solubles,%=(residue weight,g×100)/[0.25×sample weight,g×(DS,%/100)]

### Method 2—Coating Colour Solubility (S2)

Determine the percent dry substance (DS) of the sample by drying 5 g for 4 hours at 120° C. under vacuum.

Weigh 2 g of sample and transfer to a dry 200 ml Kohlrausch flask. Partially fill with water at 35° C. Adjust pH with NaOH 0.1N until a pH value of 10.0 is reached. Shake vigorously until completely in suspension and dilute to volume. Stopper flask and shake gently while submerged in a water bath at 35° C. for a total agitation time of 1 hour.

Filter through a Whatman No. 2V paper, returning the first portion of filtrate. Measure 50 ml of filtrate and transfer to a weighed evaporating dish.

Evaporate to dryness on a steam bath and dry in a vacuum oven for 1 hour at 100° C. Cool in a desiccator and weigh to the nearest mg.

DS,%=100−[(loss in weight,g×100)/(sample weight,g)]

Solubles,%=(residue weight,g×100)/[0.25×sample weight,g×(DS,%/100)]

### Method 3—AA-GWR Water Release Test

ÅA-GWR WRV-apparatus

Injection (10 mL)

Thermometer

Filter paper (blue ribbon)

Millipore filter (5 Mm pore size)

Coating colour

Stop-watch

Balance (sensibility: 0,001 g)

Both control levers—“Pressure” and “Cylinder”—have to be in the “off” position (downwards). At least three filter papers should be weighed and the figure logged (weight 1). The filters have to be placed on the rubberised plate and the Millipore filter is then placed on the filter papers with the shiny side up. Then the cylinder is placed on the plate with the ceiling upward. The whole composition is put on the metal plate and risen up by switching the “Cylinder” lever.

The sample is tempered to 30° C. and 10 mL of the coating colour is filled into the cylinder with a syringe. The rubber should be free from coating colour to avoid leakage. The device has to be closed with the plug and the pressure is switched on with the “Pressure” lever and adjusted to 1 bar. At the same time the stop-watch is started. After two minutes, the pressure is stopped and the cylinder let down. The whole composition—plate, filters, cylinder—is removed and turned over a wash-basin and the filter paper is taken and weighed. This gives weight 2. Water retention is calculated as follows: WRV [g/m²]=(weight 2−weight 1)*1250

### Method 4—Lehmann Paper Gloss 75° Test

This test is performed according to Tappi T480 om-92.

Method 5—Prüfbau Printing Gloss Test

Apparatus: Prüfbau apparatus

Printing ink: Lorilleux Rouge, Brilliant Standard 3810 (red)

Ink amount: 0.200 cm³ for coated papers, 0.250 cm³ for uncoated papers;

Time for ink distribution: 60 s

Time for inking: 30 s

Number of prints per inking: 3

Reinking: none

Pressure: 800 N

Speed: 1 m/s (constant)

Printing disc: Rubber 4 cm

Weighing unit: +/−0.1 mg

Size of test stripe: width: 4.7 cm; length: 25 cm

The exact ink amount on the paper surface should be determined in [mg] or [g] by using an analytical balance (+/−0.1 mg or +/−0.0001 g exactly). The applied ink amount can be calculated by weighing the inked printing disc before and after printing.

Coat weight in [g/m²]=Coat weight in mg divided by 8 or Coat weight in g multiplied by 125 (printed area=800 cm²)

3 stripes should be printed on each side. After drying the printed papers in a conditioned room (23° C./50%) for 24 hours the printing gloss should be determined either with Gardner or Lehmann glossmeter (10 measurements on each stripe). The printing gloss should be calculated to a coat weight of 1.2 g/m² for coated papers and 1.5 g/m² for uncoated papers by using regression analysis (either with calculator or Nomo-diagram).

### Method 6—IGT Pick-Dry Test

The dry-pick test is used to determine the surface strength of the coated and uncoated papers and boards. Picking is a surface damage caused by the adhesion force of the printing ink during the printing process. The adhesion force on the surface becomes higher at higher printing speeds and with inks exerting a higher tack. The printing pressure and ink layer thickness also influence the picking.

Test apparatus: IGT AIC2-5 apparatus
Testing ink: Lorilleux 3800-3806 depending on paper quality, IGT pick-oils with low, medium and high viscosities are also available.
Ink amount: 1.34 cm³ on the left inking cylinder and 0.94 cm³ on the right inking cylinder. 38 inking steps could be performed. 1 re-inking with 0.63 cm³ on the left cylinder: next 38 inking steps could be performed. After 1 re-inking the inking cylinders must be washed and started again.
Time of ink distribution: 2×60 s (re-inking 2×45 s)
Time for inking: 30 s on each inking cylinder

### Pressure: 350 N/cm

Printing machine speed: accelerated speed depending on the paper surface strength
Printing disc: Aluminium 1 cm
Blanket: paper
Size of test stripe: 2 cm×30 cm

The printing disc is inked according to the IGT-procedure under above-mentioned conditions. At least 3 stripes of each sample and side are printed. Only the clear visible beginning of the picking is noticed. The pick result is calculated by means of the IGT-Nomogram.

Viscosities of Test Inks for IGT Dry Pick:

| | Viscosity at 23° C. |
|---|---|
| Ink type: | Pa · s |
| H-oil | 110 |
| N-oil | 52 |
| L-oil | 17.5 |
| Lorilleux 3802 | 16 |
| Lorilleux 3803 | 26 |
| Lorilleux 3804 | 35 |
| Lorilleux 3805 | 40 |
| Lorilleux 3806 | 50 |

Method 7—Prüfbau mottling test

Mottling is the unevenness of the print of the paper or board due to irregular ink setting. It occurs on the multiple-colour offset machine by different film splitting on the successive rubber blankets and usually after first and second print. The mottling test simulates the printing process on the laboratory printing machine under constant conditions and evaluated visually after test printing.

Apparatus: Prüfbau apparatus

Printing ink: Blue ink type 520068 from M. Huber/Munich

Ink amount: 0.25 cm³

Time for ink distribution: 60 s

Time for inking: 30 s

Re-inking: none

Disc type: Rubber 4 cm for 1.print; Rubber 4 cm for 3 counter prints;

Pressure: 800 N for the printing disc; 800 N for 3 counter prints;

Speed: 0.5 m/sec (constant)

Time interval for the 3 counter prints: 1 s

Size of test stripe: width: 4.7 cm; length: 25 cm

Number of test: 1 stripe for each side

Test stripe should be printed under the above-mentioned conditions. Is after printing three counter prints must be done with the un-inked disc. The printed stripe is evaluated with an image analysing system via scanner.

The image of the paper strip is measured via a scanner in seven different resolution stages. The higher the calculated value, the stronger the mottling pronounced in this stage.

### Method 8—Coating Cracking in the Fold Test

Testing ink: Lorilleux Rouge Brilliant Standard 3810 (magenta)

Ink amount: 0.200 cm³

Time for ink distribution: 60 s

Time for inking: 30 s

Pressure: 800 N

Speed: 1 m/s (constant)

Printing disc: Rubber 4 cm

Balance: 0.1 mg exactly

Size of test stripe: width: 4.7 cm; length: 25 cm in machine direction

The exact ink amount on the paper surface should be determined in [mg] or [g] by using an analytical balance (+/−0.1 mg or +/−0.0001 g exactly). The applied ink amount can be calculated by weighing the inked printing disc before and after printing. Coat weight in [g/m²]=Coat weight in mg divided by 8 or coat weight in g multiplied by 125 (printed area=800 cm²).

For each trial, 5 stripes are printed in machine direction. After conditioning the printed papers (23° C./50%) for 24 hours, each strip is laid separately in an oven for 15 seconds at 120° C. With the printing side outside, the paper is slightly pre-folded and fixed on the Prüfbau rubber matrix.

Immediately afterwards, the paper was folded in the Prüfbau apparatus. The 5 strips were ranked and judged as a package.

Folding pressure: 1600 N

Folding (printing) disc: Aluminium 4 cm

Speed: 0.5 m/s (constant)

1. A coating composition comprising a starchy material, said material having:
a number average molecular weight (Mn) of 3 500 to 20 000 Daltons,
a granular structure before solubilisation,
a solubility at pH 7 and 20° C. (S1) of 30-90%, and
a solubility at pH 10 and 35° C. (S2) which is at least 10% greater than S1.

2. The composition of claim 1 wherein the starchy material has a DE of less than 5.

3. The composition of claim 1 wherein S2 is greater than 50%.

4. The composition of claim 1 wherein S2 is greater than 70%.

5. The composition of claim 1 wherein the starchy material is derived from a starch selected from the group consisting of: wheat starch, corn starch and mixtures thereof.

6. The composition of claim 1 further comprising one or more binders.

7. The composition of claim 6, wherein the binder is selected from the group consisting of: styrene butadiene, styrene acrylate, vinyl polymer based latexes, polyvinyl alcohol, modified starches and mixtures of two or more thereof.

8. The composition of claim 1 further comprising one or more thickeners.

9. The composition of claim 8 wherein the thickener is selected from the group consisting of: cellulose ethers, hydrocolloids, native or modified starches, synthetic polymers and mixtures of two or more thereof.

10. The composition of claim 1 further comprising at least one pigment.

11. The composition of claim 10 wherein the pigment is selected from the group consisting of: calcium carbonate, kaolin, talc, titanium dioxide, gypsum, engineered pigments, bentonite and mixtures of two or more thereof.

12. The composition of claim 1 further comprising one or more additives.

13. The composition according to claim 12 wherein the one or more additives are selected from the group consisting of: dispersing agents, whitening agents, thickeners, rheology modifiers, cross-linking agents and biocides.

14. The composition of claim 1 wherein the pH of said composition is from 7 to 12.

15. The composition of claim 15 wherein the pH of said composition is from 8 to 10.

16. A paper coating composition according to claim 1.

17. The paper coating composition of claim 16 comprising at least 50% dry substance by weight.

18. The paper coating composition of claim 16 comprising 50-80% dry substance by weight.

19. The paper coating composition of claim 16 comprising 4-10% starchy material by weight dry substance.

20. A paper product coated with the coating composition of claim 16.

21. Use of a starchy material for the preparation of a coating composition characterised in that the starchy material has:
a number average molecular weight (Mn) of 3 500 to 20 000 Daltons,
a granular structure before solubilisation,
a solubility at pH 7 and 20° C. (S1) of 30-90%, and
a solubility at pH 10 and 35° C. (S2) which is at least 10% greater than S1.
